(19) United States
(12) Patent Application Publication
(10) Pub. No.: US 2003/0094507 A1
(43) Pub. Date: May 22, 2003

(54) Water-spray apparatus for repelling and deterring birds

(76) Inventor: Anthony Anzivino, Glendale, AZ (US)

Correspondence Address: Sandra L. Etherton, Etherton Law Group, LLC, P.O. Box 27843, Tempe, AZ, 85285-7843, US

(21) Appl. No.: 09/991,734

(22) Filed: Nov. 20, 2001

(51) Int. Cl. A01G 27/00

(52) U.S. Cl. 239/70; 239/208

(57) ABSTRACT

A water sprinkler is attached to a building which automatically and periodically sprays the roof with water. The water scares the birds away, and they do not return during the “off” period of the sprinkler cycle.

### FIELD OF INVENTION

This invention relates to pest-control devices. This invention relates particularly to an apparatus for repelling and deterring birds from the roof of a building by automatically and periodically spraying the roof with water.

### BACKGROUND

Pigeons and other birds that congregate on buildings or other surfaces that people habituate are problematic. The bird droppings they leave are unsightly, messy, and can transmit disease. The molted feathers increase the mess, and flocks of birds are noisy. A wide variety of measures have been taken to abate bird nuisances, but unfortunately each has shown to have its disadvantages. The problems arising from the known devices and methods for deterring birds include harming the birds, damaging the buildings, and being unsightly, expensive, or ineffective.

Pesticides in the form of spray poison and poisoned bird feed are known. These devices can harm or kill the birds, however, which is highly objectionable to many. Further, the distressed or dead birds often fall to the ground in the target area, creating another problem that may be worse than the original one.

Physical devices such as netting, porcupine wire and metal traps are also known. These devices are usually attached to the target building or structure, so they are visible to humans and detract from the appearance of the building. Visual deterrents, such as statutes of predators, and audible deterrents have been tried but birds often become accustomed to the device and it loses its effectiveness.

Therefore, it is an object of this invention to provide an apparatus to deter and repel birds from landing on buildings or other structures such as statues, sidewalks, patio and lawn furniture or vehicles. It is a further object that the device does not harm the birds, the building, or the environment. Another object of this invention is to provide a deterrent device that is not unsightly. A further object is to provide a device for deterring and repelling birds that is simple to install and maintain.

### SUMMARY OF THE INVENTION

A water spray head is attached to a building or other surface and periodically sprays the surface with water where birds land. Preferably a rotor-type spray head is used. The spray head is attached to water tubing, which is attached to the building's water supply. In the preferred embedment, conventional sprinkler system timers, solenoid valves and anti-siphon valves are attached to the water tubing to control when a sprinkler head sprays, and the duration of the spray.

### BRIEF DESCRIPTION OF THE DRAWINGS

FIG. 1 illustrates the roof a house with the preferred embodiment of the present invention installed and operating.

FIG. 2 is a schematic illustration of the timing and spray components of the present invention.

### DETAILED DESCRIPTION OF THE INVENTION

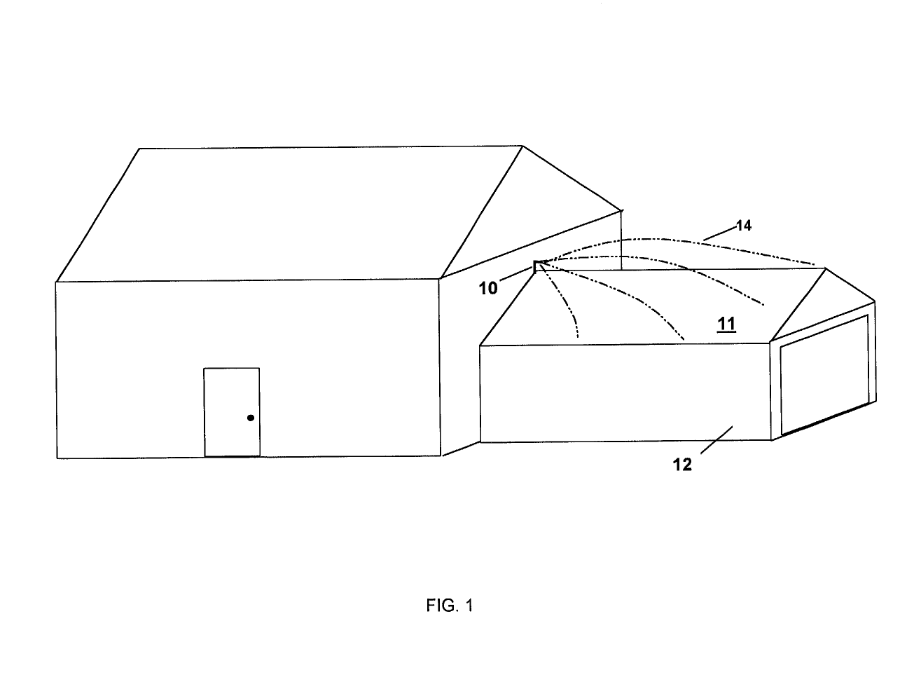

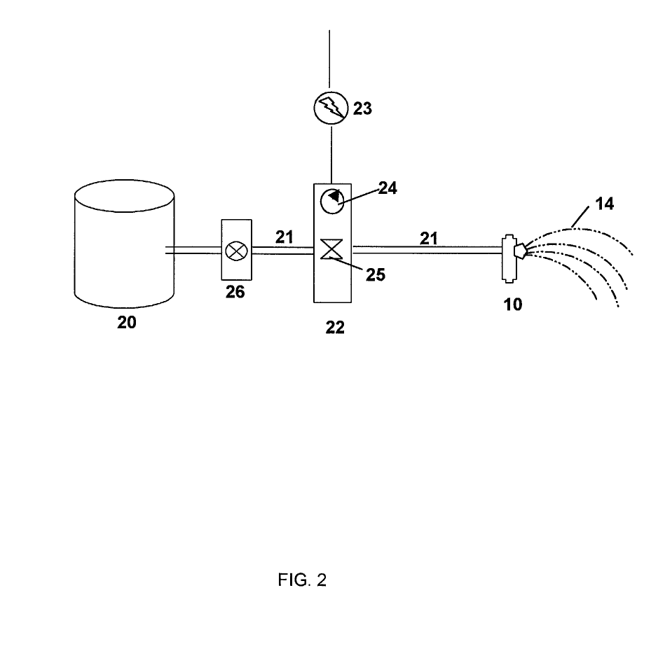

Referring to FIGS. 1 and 2, the preferred embodiment of the present invention is used to repel and deter birds from roofs. A spray head 10 for spraying water is mounted on or near the roof 11 of a building 12. The spray head 10 is connected with pipe 21 to a water source 20. The water 14 is automatically and periodically turned on with a timing means 22, which is electrically powered by battery or supplied from the building's power supply 23. The timing means is one or more timers 24 connected to a solenoid valve 25. An anti-siphon valve 26 may be installed between the sprinkler head and the water supply for preventing the water from backflowing into the water source.

In the preferred embodiment, the spray head 10, pipe 21, timer 24, and valves 25 and 26 are conventional components used to irrigate lawns. Preferably the spray head 11 is rotor type which sprays water during its rotation through a partial or whole arc. The dimension of the arc is determined by a number of factors, including the spray head's flow capacity and water pressure. Preferably, the spray head 11 is set to rotate through an arc such that the sprayed water covers substantially all of the area where the birds alight. More than one spray head may be necessary to cover the desired area.

For controlling pigeons, the timing means 22 is set to spray water for about 30 seconds once an hour, through at least one rotation of the arc. It has been found that usually the sprinkler needs to be operated only during the day, because the birds find other shelter at night. It is believed that the water scares the birds away because they do not return during the “off” period of the sprinkler cycle. The effect of this system is that the birds do not land on the roof, eliminating bird droppings and all other nuisances. As an added benefit, the roof is kept clean. Water and debris run off the roof into rain gutters or, for buildings that have no rain gutters, onto the ground below. The birds are not harmed, the building is not harmed, the roof is kept clean, and no toxic chemicals are used that might harm the environment.

The water source is typically the municipal water system, but it can also be a well, a water tank, lake, or other water source. It can be piped to the spray head through conventional plastic water pipe or metal pipe. If desired, additives that are offensive to birds can be added to the water to increase the deterrent and repellant effects. Similarly, cleaning agents can be added to the water to help clean the roof. Preferably any additive used will not be harmful to birds or the building. The pipe can be installed on the exterior of the building structure or, if a discreet appearance is desired, on the inside of the building. Similarly, the spray head may be placed in a discreet location that is not easily seen from the ground.

The preferred embodiment of the invention is used to deter and repel birds from a roof. The invention can be used for deterring and repelling bids from other structures such as statues, sidewalks, patio and lawn furniture or vehicles—wherever birds congregate and create a nuisance.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A device for deterring pests from a structure, the device comprising a water-spraying device mounted on the structure from which water sprays on the structure automatically and periodically.

2. The device according to claim 1 wherein the means for automatically and periodically spraying water comprises a timing means and a valve.

3. The device according to claim 1 wherein the structure is a roof.

4. The device according to claim 1 wherein the structure is a statue.

5. A device for deterring birds from a structure, the device comprising:
a) a spray head mounted on the structure;
b) tubing connecting the spray head to a water supply;
c) a timing means and a valve connected to the tubing between the water supply and the spray head for turning the water spray on and off wherein the water sprays automatically and periodically from the spray head to cover the structure.

6. The device of claim 5 further comprising an anti-siphon valve attached to the tubing between the sprinkler head and the water supply for preventing the water from backflowing into the water supply.

7. A device for deterring birds from the roof of a building, the device comprising:
a) a rotor-type sprinkler head mounted on the building;
b) pipe connecting the sprinkler head to a water supply;
c) one or more timers and one or more solenoid valves connected to the tubing between the water supply and the spray head for turning the water spray on and off, such that the water sprays automatically and periodically from the spray head to cover the roof; and
d) an anti-siphon valve attached to the tubing between the sprinkler head and the water supply for preventing the water from backflowing into the building's water supply.

8. The device according to claim 7 wherein the water sprays about 30 seconds every hour during the day.

9. A method for deterring pests from a structure, the method comprising automatically periodically spraying water on the structure from a water-spraying device mounted on the structure.
